(19) United States
(12) Patent Application Publication
(10) Pub. No.: US 2016/0112136 A1
(43) Pub. Date: Apr. 21, 2016

(54) OPTICAL DEVICE, OPTICAL DISTRIBUTION NETWORK AND RESPECTIVE METHODS PERFORMED THEREBY

(71) Applicant: TELEFONAKTIEBOLAGET LM ERICSSON (PUBL), Stockholm (SE)

(72) Inventor: Patryk URBAN, Vällingby (SE)

(21) Appl. No.: 14/893,923

(22) PCT Filed: May 24, 2013
(86) PCT No.: PCT/SE2013/050598

§ 371 Date: Nov. 24, 2015

(51) Int. Cl. H04B 10/27; G02B 6/293

(52) U.S. Cl. CPC H04B 10/27; G02B 6/2934

(57) ABSTRACT

An optical device, OD, for partitioning a received signal and outputting the partitions via two outputs. An optical distribution network comprising at least two Optical Network Terminations, ONTs, the ONTs being connected to the CO by the fibre ring structure, wherein each ONT is connected to the fibre ring structure by means of a respective OD is provided. The OD has a first port, a second port and a third port, each port being operable as both an input and an output interface. The first and second ports are adapted to receive an input signal, to split the signal and to output a first respective portion of the received signal through the second or first port respectively and to output a respective second portion of the received signal through the third port, the first portion of the received signal being larger than the second portion of the received signal.

### TECHNICAL FIELD

The present disclosure relates to optical networks and in particular to optical distribution networks and optical devices comprised therein.

### BACKGROUND

The number of subscribers of communication networks is constantly increasing. The distribution of these subscribers may vary substantially. There are subscribers located in distant rural areas and there are subscribers in areas of very high concentration of subscribers, e.g. in buildings, such as office buildings.

Different techniques may be suitable to provide services to different subscribers depending on the concentration of subscribers, the amount of traffic the subscribers generate and the accessibility of the area in which the subscribers are located.

One example of a technique is in e.g. an office building where a Radio Base Station, RBS may be located in a central office. The central office is connected to a fibre network comprising Optical Network Terminations, ONTs connected to e.g. radio heads in different places of the office building. In this manner, subscribers may communicate wirelessly to a communication network via the radio heads, the fibre network and the RBS.

Any network, fibre based, wireless or wire based, should provide a high level of reliability. In case a fault or failure occurs somewhere in/on the network, measures should be defined that can be taken in order to overcome the fault or failure. Such measures should be cost effective and efficient. One obvious solution of duplicating every component in a communication network may be very reliable but very expensive hence such a solution is often even an option.

### SUMMARY

The object is to obviate at least some of the problems outlined above. In particular, it is an object to provide an optical device and a method performed by an optical device for partitioning a received signal and outputting the partitions via two outputs. A further object is to provide an optical distribution network comprising a Central Office, CO, connected to a fibre ring structure and at least two Optical Network Terminations, ONTs, the ONTs being connected to the CO by the fibre ring structure, wherein each ONT is connected to the fibre ring structure by means of a respective optical device and a method performed by the optical distribution network. These objects and others may be obtained by providing an optical device and a method performed by the optical device according to the independent claims attached below. These objects and others may be obtained by providing an optical distribution network and a method performed by the optical distribution network according to the independent claims attached below.

According to an aspect an optical device having three ports, each port being operable as both an input and an output interface, and the optical device receives an input signal on one of the three ports and splits the received input signal into two partitions and outputs the respective partition on the two other ports is provided. The optical device has a first port, a second port and a third port, each port being operable as both an input and an output interface. The first port is adapted to receive an input signal, to split the signal and to output a first portion, A, of the received signal through the second port and to output a second portion, B, of the received signal through the third port, wherein the first portion, A, of the received signal is larger than the second portion, B, of the received signal. The second port is adapted to receive an input signal, to split the received signal and to output a first portion, C, of the signal through the first port and to output a second portion, D, of the received signal through the third port, wherein the first portion, C, of the received signal is larger than the second portion, D, of the received signal. The third port is adapted to receive an input signal, to split the signal and to output a first portion, E, of the received signal through the first port and to output a second portion, F, of the received signal through the second port.

According to an aspect, an optical distribution network comprising a CO connected to a fibre ring structure and at least two ONTs, the ONTs being connected to the CO by the fibre ring structure, wherein each ONT is connected to the fibre ring structure by means of a respective optical device is provided. The optical distribution network comprises the CO connected to a fibre ring structure and at least two ONTs, the ONTs being connected to the CO by the fibre ring structure, wherein each ONT is connected to the fibre ring structure by means of a respective optical device. The CO is adapted to transmit a signal to the ONTs in either direction of the fibre ring structure, wherein the optical devices are adapted to receive the signal from the CO, to direct a fraction of the signal to the respective ONT and to direct a remaining portion of the signal to the ring structure.

According to an aspect, a method performed by an optical device is provided. The optical device has a first, a second and a third port, each port being operable as both an input and an output interface. The method comprises receiving an input signal on one of the three ports and splitting the received signal into two portions and transmitting each of the respective two portions of the received signal on the other two ports, wherein when the input signal is received on the first port, the method comprises splitting the received signal and outputting a first portion, A, of the signal through the second port and outputting a second portion, B, of the received signal through the third port, wherein the first portion A of the received signal is larger than the second portion B of the received signal. When the input signal is received on the second port, the method comprises splitting the signal and outputting a first portion, C, of the received signal through the first port and outputting a second portion, D, of the received signal through the third port, wherein the first portion C of the received signal is larger than the second portion D of the received signal. When the input signal is received on the third port, the method comprises splitting the received signal and outputting a first portion, E, of the received signal to the first port and outputting a second portion, F, of the received signal to the second port.

According to an aspect, a method performed by an optical distribution network is provided. The optical distribution network comprises a CO connected to a fibre ring structure and at least two ONTs, the ONTs being connected to the CO by the fibre ring structure, wherein each ONT is connected to the fibre ring structure by means of a respective optical device. The method comprises the CO transmitting a signal to the ONTs in either direction of the fibre ring structure, the optical devices respectively receiving the signal from the CO, directing a fraction of the received signal to the respective ONT and directing a remaining portion of the signal to the ring structure.

### BRIEF DESCRIPTION OF DRAWINGS

Embodiments will now be described in more detail in relation to the accompanying drawings, in which:

FIG. 1a is a block diagram of an optical device according to an exemplifying embodiment.

FIG. 1b is a block diagram of an optical device according to still an exemplifying embodiment.

FIG. 1c is a block diagram of an optical device according to yet an exemplifying embodiment.

FIG. 2a is a block diagram of an optical distribution network according to an exemplifying embodiment.

FIG. 2b is a block diagram of an optical distribution network illustrating examples of faults or failures of the optical distribution network.

FIG. 3a is a flowchart of a method performed by the optical device according to an exemplifying embodiment.

FIG. 3b is a flowchart of a method performed by the optical device according to still an exemplifying embodiment.

FIG. 4a is a flowchart performed by an optical distribution network according to an exemplifying embodiment.

FIG. 4b is a flowchart performed by an optical distribution network according to an exemplifying embodiment.

### DETAILED DESCRIPTION

Briefly described, an optical device and a method performed by the optical device for receiving a signal, partitioning the signal and outputting the partitions of the signal are provided. Further, an optical distribution network and a method performed by the optical distribution network are provided for communicating between a central office and optical network terminations connected to the central office by optical terminals, all comprised in the optical distribution network are provided. The optical device has three ports, each port being operable as both an input and an output interface, and the optical device receives an input signal on one of the three ports and splits the received input signal into two partitions and outputs the respective partition on the two other ports.

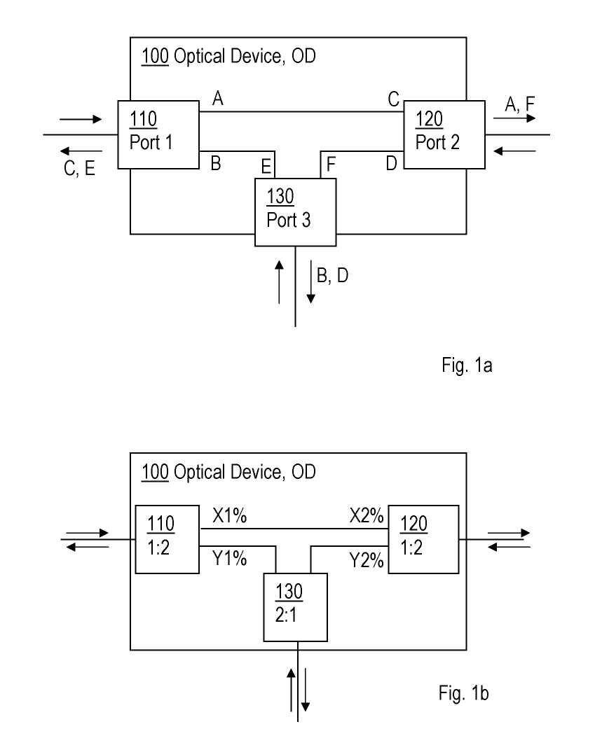

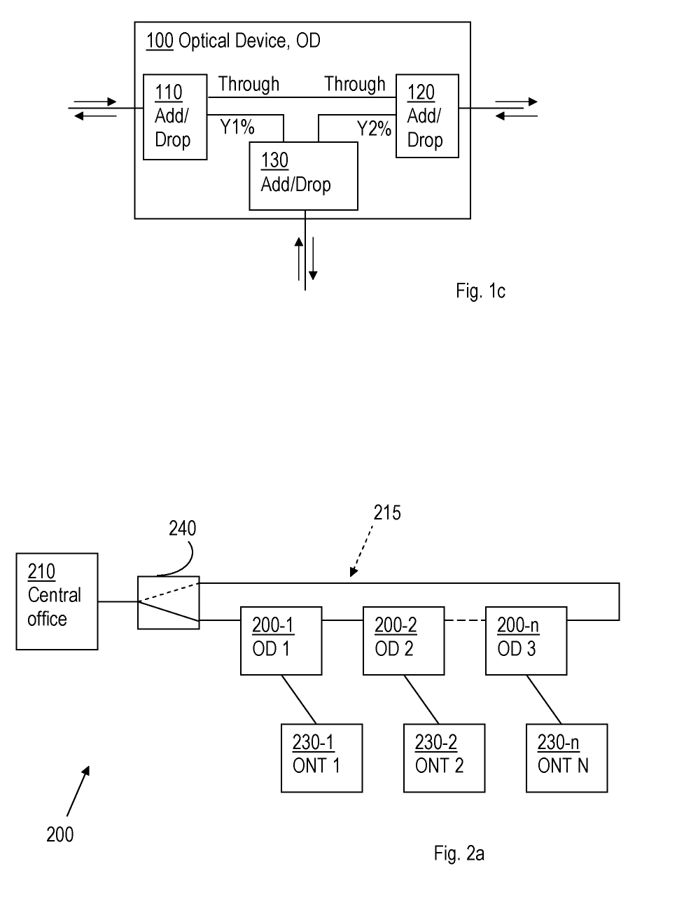

An exemplifying embodiment of such an optical device will now be described with reference to FIG. 1a.

FIG. 1a illustrates the optical device 100 having a first port 110, a second port 120 and a third port 130, each port being operable as both an input and an output interface. The first port 110 is adapted to receive an input signal, to split the signal and to output a first portion, A, of the received signal through the second port 120 and to output a second portion, B, of the received signal through the third port 130, wherein the first portion, A, of the received signal is larger than the second portion, B, of the received signal. The second port 120 is adapted to receive an input signal, to split the received signal and to output a first portion, C, of the signal through the first port 110 and to output a second portion, D, of the received signal through the third port 130, wherein the first portion, C, of the received signal is larger than the second portion, D, of the received signal. The third port 130 is adapted to receive an input signal, to split the signal and to output a first portion, E, of the received signal through the first port 110 and to output a second portion, F, of the received signal through the second port 120.

The optical device thus has three ports, port 1, port 2 and port 3. Each of these ports may operate as an input and an output meaning that the optical device 100 may receive an input signal on either one of the three ports. Depending on which port receives the signal, the signal may be split in different ways. As stated above, if the input signal is received on the first port 110, the signal is split in two portions, A and B and portion A of the signal is outputted from the optical device on the second port 120 and the portion B of the signal is outputted on the third port, wherein portion A is larger than portion B. A portion of a signal will be described in more detail below. In this manner, a received input signal being received on port 1 is split such that a larger portion of the signal is outputted from the optical device via the second port 120 and a smaller portion of the signal is outputted from the optical device via the third port 130. Similarly a received input signal being received on port 2 is split such that a larger portion of the signal is outputted from the optical device via the first port 110 and a smaller portion of the signal is outputted from the optical device via the third port 130. An input signal being received by the optical device on port 3 is split in two portions and outputted the first port 110 and second port 120. If the input signal is received on the third port, there is no limitation on how the input signal shall be split, or in other words, the size of portions E and F are arbitrary. Hence, portion E and F of the received input signal may be of the same size, portion E may be larger than portion F or portion F may be larger than portion E of the received input signal.

The optical node may have several advantages. When used in e.g. an optical distribution network connecting a node to an optical fibre, the optical device is enabled to receive a downlink transmission to the node, the downlink transmission being transmitted in any direction on the optical fibre. By splitting a received input signal such that a fraction of the received input signal is outputted on one port and a remaining portion of the signal is outputted to another port, the optical device is flexible and may be designed to optimise communication in the optical distribution network. Further, in case the optical network in which the optical device is employed changes transmission direction on the optical fibre, the optical device is still enable to receive a transmission and divert a fraction thereof to the third port and the remaining portion to the other port.

According to an embodiment, illustrated in FIG. 1b, the received signal has a signal power, wherein the optical device 100 is adapted for splitting the signal into the first portion A, C or E and the second portion B, D or F by directing a fraction of the signal power to the second portion B, D or F and the remaining signal power to the first portion A, C or E, wherein the power of the fraction of the signal power directed to the second portion B or D is smaller than the power of the remaining signal power directed to the first portion A or C.

For simplicity, assume that the signal power is 100 watt, this signal power could alternatively be expressed in percent e.g. 100%. Then out of this 100 watt or %, a fraction of the signal power is directed to the second portion B, D or F, and the remaining signal power out of the 100 Watt is directed to the first portion A, C or E. The power of the fraction of the signal power directed to the second portion B or D is smaller than the power of the remaining signal power directed to the first portion A or C. In other words, maximum 49 watt or 49% of the signal power may be directed to portion B or D, i.e. maximum 49 watt or 49% of the received signal is outputted from the optical device via the third port and minimum 51 watt or 51% of the received signal power is outputted from the optical device via the first port or the second port respectively.

FIG. 1b illustrates the optical device 100 comprising three power splitters 110, 120 and 130. This means that either the ports of FIG. 1a comprises or corresponds to respective power splitters or may be directly connected to the respective power splitters. The first power splitter 110, corresponding to or being directly connected to port 1, is a 1:2 splitter, wherein a received input signal is split such that X1% of the power of the received input signal, being the first portion A, is directed to and outputted via the second port 120, and Y1% of the power of the received input signal, being the second portion B, is directed to and outputted via the third port 130. Since A>B, then X1>Y1. Further, the second power splitter 120, corresponding to or being directly connected to port 2, is a 1:2 splitter, wherein a received input signal is split such that X2% of the power of the received input signal, being the first portion C, is directed to and outputted via the first port 110, and Y2% of the power of the received input signal, being the second portion D, is directed to and outputted via the third port 130. Since C>D, then X2>Y2. It shall be pointed out that X1 and X2 may be equal or different, and hence Y1 and Y2 may also be equal or different.

In an example, the second portion B or D of the signal or the fraction of the signal power directed to the second portion B or D is maximum 40% of the received signal power, wherein the first portion A or C of the signal or the remaining signal power directed to the first portion A or C is minimum 60% of the received signal power.

In another example, the second portion B or D of the signal or the fraction of the signal power directed to the second portion B or D is maximum 10% of the received signal power, wherein the first portion A or C of the signal or the remaining signal power directed to the first portion A or C is minimum 90% of the received signal power.

Of course other examples of the relationship between the first portion A or C and the second portion B or D are possible. It shall also be pointed out that the relationship between portion A and B may be the same or other than the relationship between portion C and D. For example, if the optical device receives the input signal on port 1, 5% of the signal is outputted on port 3 and 95% of the signal is outputted on port 2, but if the optical device receives the input signal on port 2, 11% of the signal is outputted on port 3 and 89% of the signal is outputted on port 1,

According to an embodiment, illustrated in FIG. 1c, the received signal comprises a plurality of wavelengths, wherein the optical device 100 is adapted for splitting the signal into the first portion A, C or E and the second portion B, D or F by directing some of the wavelengths of the signal to the first portion A, C or E and the remaining wavelengths of the signal to the second portion B, D or F, wherein the number of wavelengths in portion A and C are higher than the number of wavelength in portion B and D if the number of wavelength are at least three.

In an example, the number of wavelengths directed to the second portion B or D is at least 1.

To exemplify such scenarios, a received signal comprises a plurality of wavelengths. Merely as an example, assume the received input signal comprises wavelengths λ₁, λ₂, λ₃, λ₄, λ₅, λ₆ and λ₇. In this example, if the input signal is received on port 1 or 2, i.e. the first port 110 or the second port 120, then wavelength λ₄ being portion B or D respectively is directed to port 3, i.e. the third port 130, and the remaining wavelengths, λ₁, λ₂, λ₃, λ₅, λ₆ and λ₇ being portion A or C are directed to the other port, i.e. port 2 (if the signal is received on port 1) or port 1 (if the signal is received on port 2) respectively. It shall be pointed out that this is merely an example and in another example, if the input signal is received on port 1 or 2, i.e. the first port 110 or the second port 120, then wavelengths λ₂ and λ₃ being portion B or D are directed to port 3, i.e. the third port 130, and the remaining wavelengths, λ₁, λ₄, λ₅, λ₆ and λ₇ being portion A or C are directed to the other port, i.e. port 2 (if the signal is received on port 1) or port 1 (if the signal is received on port 2) respectively.

FIG. 1c illustrates the optical device 100 comprising three add/drop filters 110, 120 and 130. This means that either the ports of FIG. 1a comprises or corresponds to respective add/drop filters or may be directly connected to the respective add/drop filters. When the first add/drop filter 110, corresponding to or being directly connected to port 1, receives an input signal, then the first add/drop filter 110 drops at least one wavelength to the third port 130. In other words, the first add/drop filter 110 directs at least one wavelength, being the second portion B, to the third port 130 to be outputted from the third port 130 and remaining wavelengths, being the first portion A, to the second port 120 to be outputted from the second port 120. Since A>B, then the number of wavelengths dropped to, or directed to the third port is smaller than the number of wavelengths directed to the second port 120. When the second add/drop filter 120, corresponding to or being directly connected to port 2, receives an input signal, then the second add/drop filter 120 drops at least one wavelength to the third port 130. In other words, the second add/drop filter 120 directs at least one wavelength, being the second portion D, to the third port 130 to be outputted from the third port 130 and remaining wavelengths, being the first portion C, to the first port 110 to be outputted from the first port 10. Since C>D, then the number of wavelengths dropped to, or directed to the third port is smaller than the number of wavelengths directed to the first port 110.

Embodiments herein also relate to an optical distribution network comprising a Central Office, CO, connected to a fibre ring structure and at least two Optical Network Terminations, ONTs, the ONTs being connected to the CO by the fibre ring structure, wherein each ONT is connected to the fibre ring structure by means of a respective optical device.

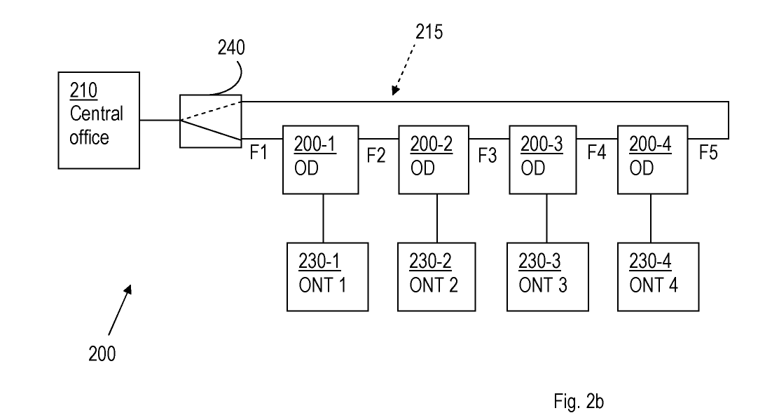

Such embodiments of an optical distribution network will now be described with reference to FIG. 2a. FIG. 2a illustrates the optical distribution network 200 comprising a Central Office, CO, 210 connected to a fibre ring structure 215 and at least two Optical Network Terminations, ONTs, 230-1, 230-2, 230-n, the ONTs being connected to the CO 210 by the fibre ring structure 215, wherein each ONT 230-1, 230-2, 230-n is connected to the fibre ring structure 215 by means of a respective optical device 200-1, 200-2, 200-n. The CO 210 is adapted to transmit a signal to the ONTs 230-1, 230-2, 230-n in either direction of the fibre ring structure, wherein the optical devices 200-1, 200-2, 200-n are adapted to receive the signal from the CO 210, to direct a fraction of the signal to the respective ONT 230-1, 230-2, 230-n and to direct a remaining portion of the signal to the ring structure 215.

The CO 210 is illustrated being connected to the fibre ring structure 215 via a switch 240. The switch 240 illustrates that the CO may transmit signals in clockwise direction, counter clockwise direction or in both directions simultaneously. This means also that the CO is enabled to receive signals in either direction. Merely as an example, assume that the CO 210 transmits a signal in counter clockwise direction so that the first optical device to receive the signal is the first optical device 200-1. also denoted OD 1. The first optical device 200-1 thus directs a fraction of the received signal to the ONT connected to it, that is the first ONT 230-1, also denoted ONT 1. The first optical device 200-1 directs the remaining portion of the signal to the ring structure, towards the second optical device 200-2, also denoted OD 2. The second optical device 200-2 directs a fraction of the received signal to the ONT connected to it, that is the second ONT 230-2, also denoted ONT 2. The second optical device 200-2 directs the remaining portion of the signal to the ring structure, towards the third optical device 200-3, and so on. It shall be pointed out that each optical device may have an individual ratio between the fraction of the received signal to be directed to a respective ONT and the remaining signal which is re-introduced to the fibre ring structure, or forwarded to a neighbouring optical device and ONT.

In this manner, the signal transmitted by the CO 210 (also referred to as a downlink signal) may be distributed to all ONTs 230-1 to 230-n on the fibre ring structure. Again it shall be pointed out that the CO 210 may alternatively transmit the signal in the opposite direction such that optical device 200-n is the first optical device to receive the signal transmitted from the CO 210. Alternatively, the CO 210 may transmit one signal in one the direction and simultaneously, or consecutively, transmit one signal in the opposite direction.

A signal transmitted by an ONT 230 230-1 to 230-n (also referred to as an uplink signal) will be received by its respective optical device 200-1 to 200-n. The optical devices will split the uplink signal received from respective ONTs and output a first part of the uplink signal on its first port and a second part of the uplink signal on its second port. Hence, uplink signals transmitted from the ONT may propagate in both directions, clockwise and counter clockwise, to be received by the CO 210.

The optical distribution network may have several advantages. The optical devices are enabled to receive a downlink transmission to a node (ONT), the downlink transmission being transmitted in any direction on the optical fibre. By splitting a received input signal such that a fraction of the received input signal is outputted on one port and a remaining portion of the signal is outputted to another port of the optical device. the optical device is flexible and may he designed to optimise communication in the optical distribution network. Further, in case the optical network in which the optical device is employed changes transmission direction on the optical fibre, the optical device is still enable to receive a transmission and divert a fraction thereof to the third port and the remaining portion to the other port.

According to an embodiment, at least one of the optical devices 200-1, 200-2, 200-n corresponds to the optical device 100 described above in conjunction with FIGS. 1a-1c.

In an example, the first port and the second port of the optical device are connected to the fibre ring structure 215 and the third port of the optical device is connected to a respective ONT 230-1, 230-2, 230-n.

The optical device 100 described above enable flexible design of the optical distribution network. Merely as an example, assume that there are seven optical devices and hence seven ONTs comprised in the fibre ring structure 215. Assume that the CO 210 sends a signal comprising seven wavelengths and that the CO 210 sends the signal in counter-clockwise direction so that the first optical device 200-1 receives the signal first. The signal comprises wavelengths λ₁, λ₂, λ₃, λ₄, λ₅, λ₆ and λ₇. In this example, the input signal is received on the first port of the first optical device 200-1. The first optical device directs a first portion of the wavelengths to the second ports to be outputted from the optical device and a second portion of the wavelengths to the third port to be outputted to the first ONT 230-1. The second portion comprises wavelength λ₁ and the second portion comprises wavelengths λ₂, λ₃, λ₄, λ₅, λ₆ and λ₇. This means that λ₁ and is outputted from the first optical device 200-1 to the first ONT 230-1 and the remaining wavelengths λ₂, λ₃, λ₄, λ₅, λ₆ and λ₇ are outputted by the second port of the optical device to the fibre ring 215 in direction towards the second optical device 200-2. The second optical device receives the signal comprising wavelengths λ₂^{,} λ₃, λ₄, λ₅, λ₆ and λ₇ on its first port, directs wavelength λ₂ to the second ONT 230-2 and directs the remaining wavelengths λ₃, λ₄, λ₅, λ₆ and λ₇ to its second port to be outputted from the second optical device 200-2 on the fibre ring structure 215 in direction towards the third ONT and so on. Hence, each optical device in this example directs one wavelength to a respective ONT being connected to it and forwards the remaining wavelengths to a neighbouring optical device and ONT. The seventh optical device will however only receive one wavelength, λ₇, which it will direct to its ONT and there will be no remaining wavelength to output via its second port to the fibre ring structure 215. Thus the CO 210 may send one signal comprising all wavelengths to be delivered to a plurality of ONTs 230.

Should the CO 210 however change transmission direction so that the seventh optical device receives the signal comprising all wavelengths λ₁, λ₂, λ₃, λ₄, λ₅, λ₆ and λ₇, the seventh optical device receives the signal on its second port. The seventh optical device may then direction a fraction of the wavelengths, i.e. the signal, to its third port for outputting to its ONT, the fraction being λ₇ and output the remaining portion of the signal, i.e. wavelengths λ₁, λ₂, λ₃, λ₄, λ₅ and λ₆ from its first port to be received by the sixth optical device on its second port. The sixth optical device hence receives the signal comprising wavelengths λ₁, λ₂, λ₃, λ₄, λ₅ and λ₆ on its second ports, directs a fraction of the signal, i.e. λ₆, to its third port for outputting to its ONT and the remaining signal comprising wavelengths λ₁, λ₂, λ₃, λ₄ and λ₅ to its first port for outputting towards the fifth optical device, and so on. The first optical device 200-1 will however only receive one wavelength, λ₁, which it will direct to its ONT 230-1 and there will be no remaining wavelength to output via its first port to the fibre ring structure 215.

In yet another example, the CO 210 outputs a signal comprising wavelengths λ₁, λ₂ and λ₃ in a counter clockwise direction and a signal comprising wavelengths λ₄, λ₅, λ₆ and λ₇ in a clockwise direction. Hence, first optical device 200-1 receives, on its first port, the input signal comprising wavelengths λ₁, λ₂ and λ₃. The first optical device directs a first portion of the wavelengths to the second ports to be outputted from the optical device and a second portion of the wavelengths to the third port to be outputted to the first ONT 230-1. The second portion comprises wavelength λ₁ and the second portion comprises wavelengths λ₂ and λ₃. This means that λ₁ and is outputted from the first optical device 200-1 to the first ONT 230-1 and the remaining wavelengths λ₂ and λ₃ are outputted by the second port of the optical device to the fibre ring 215 in direction towards the second optical device 200-2, and so on. The seventh optical device receives, on its second port, the input signal comprising wavelengths λ₄, λ₅, λ₆ and λ₇. The seventh optical device may then direction a fraction of the wavelengths, i.e. the signal, to its third port for outputting to its ONT, the fraction being λ₇ and output the remaining portion of the signal, i.e. wavelengths λ₄, λ₅ and λ₆ from its first port to be received by the sixth optical device on its second port, and so on.

According to an embodiment, the CO 210 is adapted to detect a fault or failure on the fibre ring structure 215, and in response to detecting the fault or failure, to change the transmission direction of at least a part of the signal on the fibre ring structure.

In an example, the CO 210 is adapted to, in response to detecting the fault or failure, transmitting a first part of the signal in a first direction of the fibre ring structure and transmitting a second part of the signal in the opposite direction on the fibre ring structure 215.

Looking at FIG. 2b, an example is illustrated comprising four optical devices and four respective ONTs. FIG. 2b also illustrates five possible positions F1, F2, F3, F4 and F5 of the fibre ring structure where a possible fault or failure may occur. Assume that the CO 210 is transmitting only in counter clockwise direction so that the first optical device 200-1 is the first optical device to receive the signal. If a fault occurs at e.g. location F1, then no optical device may be able to receive the signal and hence the whole optical distribution network fails. If a fault occurs at location F1, the CO 210 may switch transmission direction of the whole signal so that the whole signal is transmitted in clockwise direction. Then all optical devices may be able to receive a signal from the CO 210.

Any ONT 230-1 to 230-4 transmitting an uplink signal to the CO 210 will still be able to do so successfully since each respective optical device splits the uplink signal and outputs a first part to its first port and a second part to its second port. In this example, all respective parts of an uplink signal from an ONT being outputted on the first port of a respective optical device will be lost, but all parts of an uplink signal from an ONT being outputted on the second port of a respective optical device will be received by the CO, since each uplink signal will propagate successfully from the second port in the counter clockwise direction towards the CO 210.

Assume that the CO 210 is transmitting only in clockwise direction so that the fourth optical device 200-4 is the first optical device to receive the signal. If a fault occurs at e.g. location F5, then no optical device may be able to receive the signal and hence the whole optical distribution network fails. If a fault occurs at location F5, the CO 210 may switch transmission direction of the whole signal so that the whole signal is transmitted in counter clockwise direction. Then all optical devices may be able to receive a signal from the CO 210.

Any ONT 230-1 to 230-4 transmitting an uplink signal to the CO 210 will still be able to do so successfully since each respective optical device splits the uplink signal and outputs a first part to its first port and a second part to its second port. In this example, all respective parts of an uplink signal from an ONT being outputted on the second port of a respective optical device will be lost, but all parts of an uplink signal from an ONT being outputted on the first port of a respective optical device will be received by the CO 210, since each uplink signal will propagate successfully from the second port in the clockwise direction towards the CO 210.

In case a fault occurs at any other possible location, F2, F3 or F4, then the CO may transmit a first part of the signal in a first direction of the fibre ring structure and transmitting a second part of the signal in the opposite direction on the fibre ring structure. Assume for example that the CO 210 is transmitting in either the clockwise direction or the counter clockwise direction. Assume a fault occurs at any of fault locations F2, F3 or F4. Then, by transmitting a first part of the signal in a first direction, e.g. counter clockwise direction and a second part of the signal in a second direction, e.g. clockwise direction, each optical device, and consequently each ONT, may receive the signal. Merely as an example, assume that a fault occurs at fault location F2. Then the CO 210 transmits a first part of the signal in the counter clockwise direction, which is received by the first optical device 210-1. The CO 210 transmits a second part of the signal in the clockwise direction, which is received by the forth, third and second optical device 210-4, 200-3 and 200-2. Any uplink transmission from the first ONT 230-1 will be split by the first optical device 200-1, and the part of the uplink signal outputted on its first port may be successfully received by the CO 210. Any uplink transmission from ONT 2, ONT 3 or ONT 4 will likewise be split at respective optical device 200-2, 200-3 and 200-4, wherein parts outputted on respective first ports of the optical devices may be lost due to the fault or failure at F2. However, parts outputted on respective second ports of the optical devices, propagating in the counter clockwise direction, may be successfully received by the CO 210.

According to an embodiment, the signal is transmitted with an original transmission power before detection of the fault or failure and in the first direction, wherein transmitting the first part of the signal in the first direction of the fibre ring structure corresponds to transmitting the signal at a fraction of the original transmission power in the first direction and transmitting the second part of the signal in the opposite direction on the fibre ring structure corresponds to transmitting the signal with a transmission power equal to the original transmission power minus the fraction of the original transmission power in the opposite direction on the fibre ring structure.

Assume again that the original signal is transmitted at a transmission power of 100 watt or 100% and in the first direction. In case a fault or failure is detected, the CO 210 may transmit a first part of the signal, e.g. 40 watt or 40% in the first direction and transmit 60 watt or 60% in the opposite direction on the fibre ring structure. Assume that the optical distribution network comprises four ONTs as illustrated in FIG. 2b. Assume further that the CO 210 transmits the original signal at a transmission power of 100 watt or 100% in the counter clockwise direction and that a fault or failure occurs at e.g. F3. The CO 210 then continues transmitting the signal in the counter clockwise direction but at a fraction of its original transmission power, e.g. 50 watt or 50% and also starts transmitting the signal in the clockwise direction at a transmission power equal to the original transmission power minus the fraction of the original transmission power, i.e. 50 watt or 50%.

According to an embodiment, the signal transmitted before detection of the fault or failure comprises a plurality of wavelengths and the signal is transmitted in the first direction, wherein transmitting the first part of the signal in the first direction on the fibre ring structure corresponds to transmitting some of the wavelengths of the plurality of wavelengths in the first direction and transmitting the second part of the signal in the opposite direction on the fibre ring structure corresponds to transmitting the remaining wavelengths of the plurality of wavelengths in the opposite direction on the fibre ring structure.

Referring again to FIG. 2b, assume the CO 210 transmits an original signal comprising wavelengths λ₁, λ₂, λ₃ and λ₄ in the counter clockwise direction. Assume further that a fault or failure occurs at location F3. Upon detecting the fault or failure, the CO 210 continues transmitting a first part of the original signal in the first direction, i.e. the counter clockwise direction, the wavelengths being e.g. wavelengths λ₁ and λ₂. The CO 210 also starts transmitting a second part of the original signal in the opposite direction, i.e. the clockwise direction, the wavelengths being e.g. λ₃ and λ₄.

According to still an embodiment, the CO further is adapted to locate where on the fibre ring structure the fault or failure has occurred; and determining the size of the fraction of the original transmission power to be sent in the first direction and the size of the original transmission power minus the fraction of the original transmission power to be sent in the opposite direction or determining which wavelengths should be transmitted in the first direction and which remaining wavelengths should be transmitted in the opposite direction based on the location of the fault or failure.

By locating the fault or failure, the CO 210 is enabled to determine the size of the fraction of the original transmission power to be sent in the first direction and the size of the original transmission power minus the fraction of the original transmission power to be sent in the opposite direction or determining which wavelengths should be transmitted in the first direction and which remaining wavelengths should be transmitted in the opposite direction based on the location of the fault or failure.

Looking at FIG. 2b, a fault or failure occurring at locations F1 or F5 may cause the CO 210 to transmit the signal, i.e. the downlink signal, in one direction in order for the signal to be received by all ONTs via the respective optical devices. A fault or failure at F1 may cause the CO 210 to transmit only in the clockwise direction, whereas a fault or failure at F5 may cause the CO 210 to transmit only in the counter clockwise direction.

In case a fault or failure occurs at F2, then the CO 210 may decide to transmit only wavelength λ₁ of a downlink signal comprising wavelengths λ₁, λ₂, λ₃ and λ₄ in the counter clockwise direction and the remaining wavelengths λ₂, λ₃ and λ₄ in the clockwise direction. Alternatively, the CO may decide to transmit an original signal of 100 watt or 100% with 25 watt or 25% in the counter clockwise direction and transmit 75 watt or 75% of the original signal of 100 watt or 100% in the clockwise direction.

In case a fault or failure occurs at F4, then the CO 210 may decide to transmit wavelengths λ₁ and λ₂ of a downlink signal comprising wavelengths λ₁, λ₂, λ₃ and λ₄ in the counter clockwise direction and the remaining wavelengths λ₃ and λ₄ in the clockwise direction. Alternatively, the CO may decide to transmit an original signal of 100 watt or 100% with 75 watt or 75% in the counter clockwise direction and transmit 25 watt or 25% of the original signal of 100 watt or 100% in the clockwise direction.

The embodiments described above address the optical backhaul/fronthaul area as well as fixed access. All of them are further described with most generic term Fibre-To-The-X (FTTX), where X states for any placement of the fibre termination at the downstream/downlink side. So X could be C for Curb, B for Building, A for Antenna, Rh for Radio Head etc. The transmission may be analogue or digital, Common Public Radio Interface CPRI or packet. The embodiments are directed towards the physical, PHY, layer of the optical distribution network.

The embodiments improve reliability of the optical distribution network and therefore the complete access/backhaul/fronthaul system. This is achieved through ring structure of the optical distribution network and special optical devices. The optical devices are fully passive, simple and cheap.

The optical distribution network may be a Passive Optical Network (PON) employing Time Division Multiplexing, TDM-PON, or Wavelength Division Multiplexing, WDM-PON. A WDM-PON may be supported by optical distribution network s with in-field filtering, e.g. Arrayed Waveguide Gratings, AWGs, or with optical power splitters followed by filtering capability at the ONT side. On the other hand, TDM-PON can be only realized on splitter-based optical distribution network.

Cascades of splitters as well as different mixes of the above are also possible. The presented embodiments are applicable to both WDM and TDM transmission, but for the sake of clarity and simplicity, only WDM transmission has been described above. WDM transmission provides wavelength point-to-point connectivity on a shared fibre plant, so no special time synchronisation is needed.

It shall be noted that power splitters (illustrated in FIG. 1b) are wavelength independent with respect to the optical bandwidth they are operating. This means that all optical spectrum components are divided equally in power. The splitting ratios may be designed in such a way that every ONT receives the same optical power, preferably. This would provide a uniform distribution of loss (per ONT) which may alleviate the need for burst-mode reception of the upstream signals at the OLT receiver for digital transmission. Also if powering over fibre is to be applied on the same fibre plant, equal distribution of loss would result in the same remote powering efficiency across the complete network. Finally, for antenna units with simple analogue linear receiver circuit, this would mean that power at the antenna interface is also uniform across the network.

The switch 240 illustrated in FIGS. 2a and 2b may be an optical switch, wavelength selective switch or a variable split-ratio power splitter.

In case the optical device comprises add-drop filters as illustrated in FIG. 1c, the optical device may be built on the basis of simple thin film filters, cheap and compact. Their function is to filter a dedicated wavelength and drop it towards ONT as described above. The same or another wavelength can be added in the uplink direction which may require a more advanced (still cheap) solution for the optical device.

Embodiments herein also relate to a method performed by the optical device. The method has the same technical features, objects and advantages as the optical device. The method performed by the optical device will only be described in brief in order to avoid unnecessary repetition.

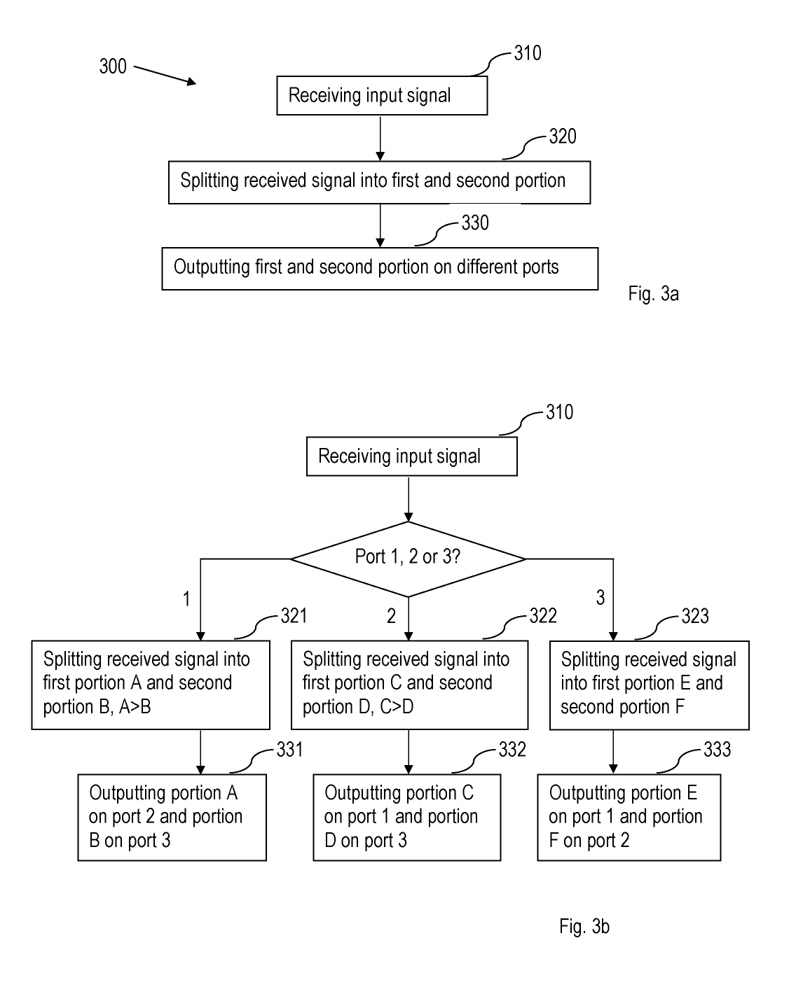

FIGS. 3a and 3b are flowcharts of a method performed by the optical device according to exemplifying embodiments. The optical device has a first, a second and a third port, each port being operable as both an input and an output interface. FIGS. 3a and 3b illustrates the method comprising: receiving 310 an input signal on one of the three ports and splitting 320 the received signal into two portions and transmitting 330 each of the respective two portions of the received signal on the other two ports, wherein when the input signal is received on the first port, the method comprises splitting 321 the received signal and outputting 331 a first portion, A, of the signal through the second port and outputting 331 a second portion, B, of the received signal through the third port, wherein the first portion A of the received signal is larger than the second portion B of the received signal. When the input signal is received on the second port, the method comprises splitting 322 the signal and outputting 332 a first portion, C, of the received signal through the first port and outputting 332 a second portion, D, of the received signal through the third port, wherein the first portion C of the received signal is larger than the second portion D of the received signal. When the input signal is received on the third port, the method comprises splitting 323 the received signal and outputting 333 a first portion, E, of the received signal to the first port and outputting 333 a second portion, F, of the received signal to the second port.

The method performed by the optical device has the same advantages as the optical device. When the optical device is used in e.g. an optical distribution network connecting a node to an optical fibre, the optical device is enabled to receive a downlink transmission to the node, the downlink transmission being transmitted in any direction on the optical fibre. By splitting a received input signal such that a fraction of the received input signal is outputted on one port and a remaining portion of the signal is outputted to another port, the optical device is flexible and may be designed to optimise communication in the optical distribution network. Further, in case the optical network in which the optical device is employed changes transmission direction on the optical fibre, the optical device is still enable to receive a transmission and divert a fraction thereof to the third port and the remaining portion to the other port.

According to an embodiment, the received signal has a signal power, wherein splitting the signal into the first portion A, C or E and the second portion B, D or F comprises directing a fraction of the signal power to the second portion B, D or F and the remaining signal power to the first portion A, C or E, wherein the power of the fraction of the signal power directed to the second portion B or D is smaller than the power of the remaining signal power directed to the first portion A or C.

According to still an embodiment, the second portion B or D of the signal or the fraction of the signal power directed to the second portion B or D is maximum 40% of the received signal power, wherein the first portion A or C of the signal or the remaining signal power directed to the first portion A or C is minimum 60% of the received signal power.

According to yet an embodiment, the second portion B or D of the signal or the fraction of the signal power directed to the second portion B or D is maximum 10% of the received signal power, wherein the first portion A or C of the signal or the remaining signal power directed to the first portion A or C is minimum 90% of the received signal power.

According to an embodiment, the received signal comprises a plurality of wavelengths, wherein splitting the signal into the first portion A, C or E and the second portion B, D or F comprises directing some of the wavelengths of the signal to the first portion A, C or E and the remaining wavelengths of the signal to the second portion B, D or F, wherein the number of wavelengths in portion A and C are higher than the number of wavelength in portion B and D.

According to still an embodiment, the number of wavelengths directed to the second portion B or D is at least 1.

Embodiments herein also relate to a method performed by the optical distribution network. The method has the same technical features, objects and advantages as the optical distribution network. The method performed by the optical distribution network will only be described in brief in order to avoid unnecessary repetition.

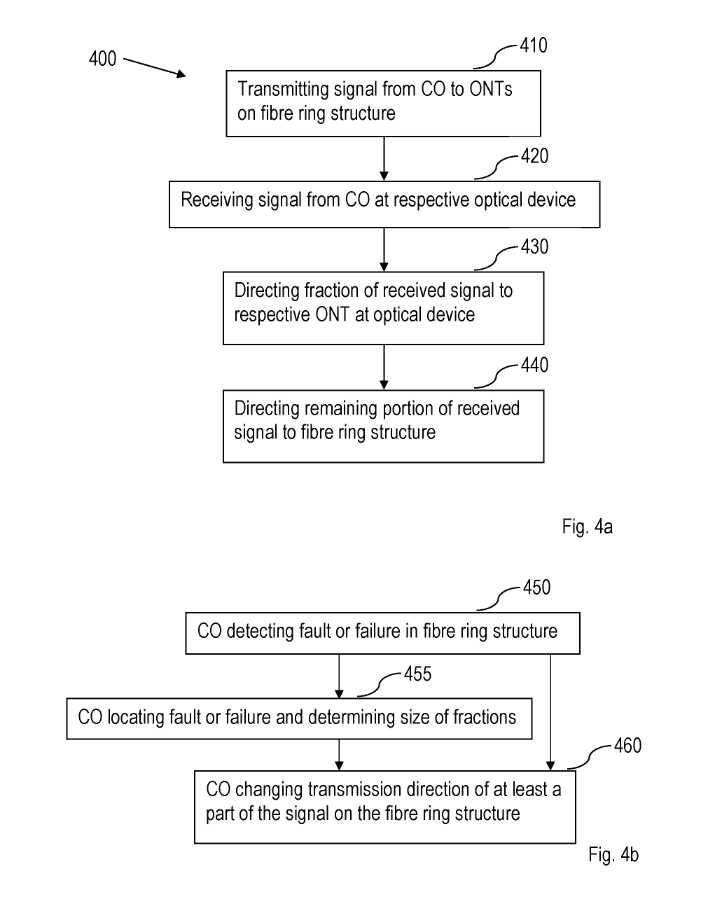

FIG. 4a is a flowchart of a method performed by the optical distribution network. The optical distribution network comprises a CO connected to a fibre ring structure and at least two ONTs, the ONTs being connected to the CO by the fibre ring structure, wherein each ONT is connected to the fibre ring structure by means of a respective optical device. FIG. 4 illustrates the method comprising the CO transmitting 410 a signal to the ONTs in either direction of the fibre ring structure, the optical devices respectively receiving 420 the signal from the CO, directing 430 a fraction of the received signal to the respective ONT and directing 440 a remaining portion of the signal to the ring structure.

The method performed by the optical distribution network has the same advantages as the optical distribution network. The optical devices are enabled to receive a downlink transmission to a node (ONT), the downlink transmission being transmitted in any direction on the optical fibre. By splitting a received input signal such that a fraction of the received input signal is outputted on one port and a remaining portion of the signal is outputted to another port of the optical device, the optical device is flexible and may be designed to optimise communication in the optical distribution network. Further, in case the optical network in which the optical device is employed changes transmission direction on the optical fibre, the optical device is still enable to receive a transmission and divert a fraction thereof to the third port and the remaining portion to the other port.

According to an embodiment, at least one optical device performs the method described above in conjunction with FIGS. 3a and 3b, wherein the first port and the second port of the optical device are connected to the fibre ring structure and the third port of the optical device is connected to a respective ONT.

According to still an embodiment illustrated in FIG. 4b, the method further comprises the CO detecting 450 a fault or failure on the fibre ring structure, and in response to detecting the fault or failure, changing 460 the transmission direction of at least a part of the signal on the fibre ring structure.

According to still an embodiment, the method further comprises the CO, in response to detecting the fault or failure, transmitting a first part of the signal in a first direction of the fibre ring structure and transmitting a second part of the signal in the opposite direction on the fibre ring structure.

According to yet an embodiment, the signal is transmitted with an original transmission power before detection of the fault or failure and in the first direction, wherein transmitting the first part of the signal in the first direction of the fibre ring structure corresponds to transmitting the signal at a fraction of the original transmission power in the first direction and transmitting the second part of the signal in the opposite direction on the fibre ring structure corresponds to transmitting the signal with a transmission power equal to the original transmission power minus the fraction of the original transmission power in the opposite direction on the fibre ring structure.

According to an embodiment, the signal transmitted before detection of the fault or failure comprises a plurality of wavelengths and the signal is transmitted in the first direction, wherein transmitting the first part of the signal in the first direction on the fibre ring structure corresponds to transmitting some of the wavelengths of the plurality of wavelengths in the first direction and transmitting the second part of the signal in the opposite direction on the fibre ring structure corresponds to transmitting the remaining wavelengths of the plurality of wavelengths in the opposite direction on the fibre ring structure.

According to still an embodiment, the method further comprises the CO further locating 455 where on the fibre ring structure the fault or failure has occurred; and determining the size of the fraction of the original transmission power to be sent in the first direction and the size of the original transmission power minus the fraction of the original transmission power to be sent in the opposite direction or determining which wavelengths should be transmitted in the first direction and which remaining wavelengths should be transmitted in the opposite direction based on the location of the fault or failure.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. An optical device comprising:
a first port;
a second port; and
a third port, wherein each port being operable as both an input and an output interface, and wherein:
the first port is adapted to receive a first input signal, to split the first input signal and to output a first portion, A, of the received first input signal through the second port and to output a second portion, B, of the received first input signal through the third port, wherein the first portion, A, of the received first input signal is larger than the second portion, B, of the received first input signal;
the second port is adapted to receive a second input signal, to split the received second input signal and to output a first portion, C, of the received second input signal through the first port and to output a second portion, D, of the received second input signal through the third port, wherein the first portion, C, of the received second input signal is larger than the second portion, D, of the received second input signal; and
the third port is adapted to receive a third input signal, to split the third input signal and to output a first portion, E, of the received third input signal through the first port and to output a second portion, F, of the received third input signal through the second port.

2. The optical device according to claim 1, wherein each respective received input signal has a respective signal power, wherein the optical device is adapted for splitting the received input signals into the first portion A, C or E and the second portion B, D or F by directing a fraction of the respective signal power to the second portion B, D or F and the remaining respective signal power to the first portion A, C or E, wherein the power of the fraction of the respective signal power directed to the second portion B or D is smaller than the power of the remaining respective signal power directed to the first portion A or C.

3. The optical device according to claim 2, wherein the second portion B or D of the respective received input signal or a fraction of a respective signal power directed to the second portion B or D is maximum 40% of the respective signal power, wherein the first portion A or C of the respective received input signal or the remaining respective signal power directed to the first portion A or C is minimum 60% of the respective signal power.

4. The optical device according to claim 1, wherein the second portion B or D of the respective received input signal or a fraction of a respective signal power directed to the second portion B or D is maximum 10% of the respective signal power, wherein the first portion A or C of the respective received input signal or the remaining respective signal power directed to the first portion A or C is minimum 90% of the respective signal power.

5. The optical device according to claim 1, wherein each respective received input signal comprises a plurality of wavelengths, wherein the optical device is adapted for splitting the respective received input signal into the first portion A, C or E and the second portion B, D or F by directing some of the wavelengths of the respective received input signal to the first portion A, C or E and the remaining wavelength or wavelengths of the respective received input signal to the second portion B, D or F, wherein the number of wavelengths in portion A or C is respectively higher than the number of wavelengths in portion B or D.

6. The optical device according to claim 5, wherein the number of wavelengths directed to the second portion B or D is at least 1.

7. An optical distribution network comprising a Central Office (CO) connected to a fibre ring structure and at least two Optical Network Terminations (ONTs), the ONTs being connected to the CO by the fibre ring structure, wherein each ONT is connected to the fibre ring structure by means of a respective optical device, wherein the CO is adapted to transmit a signal to the ONTs in either direction of the fibre ring structure, wherein the optical devices are adapted to receive the signal from the CO, to direct a fraction of the signal to a respective ONT and to direct a remaining portion of the signal to the ring structure.

8. The optical distribution network according to claim 7, wherein at least one of the optical devices is operable as both an input and an output interface, and wherein the at least one optical device comprises:
a first port;
a second port; and
a third port, and wherein:
the first port is adapted to receive a first input signal, to split the first input signal and to output a first portion, A, of the received first input signal through the second port and to output a second portion, B, of the received first input signal through the third port, wherein the first portion, A, of the received first input signal is larger than the second portion, B, of the received first input signal;
the second port is adapted to receive a second input signal to split the received second input signal and to output a first portion, C, of the received second input signal through the first port and to output a second portion, D, of the received second input signal through the third port, wherein the first portion, C, of the received second input signal is larger than the second portion, D, of the received second input signal; and
the third port is adapted to receive a third input signal, to split the third input signal and to output a first portion, E, of the received third input signal through the first port and to output a second portion, F, of the received third input signal through the second port.

9. The optical distribution network according to claim 8, wherein the first port and the second port of the at least one optical device are connected to the fibre ring structure and the third port of the at least one optical device is connected to a respective one of the ONTs.

10. The optical distribution network according to claim 9, wherein the CO is adapted to detect a fault or failure on the fibre ring structure, and in response to detecting the fault or failure to change a transmission direction of at least a part of the signal on the fibre ring structure.

11. The optical distribution network according to claim 10, wherein the CO is adapted to, in response to detecting the fault or failure, transmitting a first part of the signal in a first direction of the fibre ring structure and transmitting a second part of the signal in the opposite direction on the fibre ring structure.

12. The optical distribution network according to claim 11, wherein the signal is transmitted with an original transmission power before detection of the fault or failure and in the first direction, wherein transmitting the first part of the signal in the first direction of the fibre ring structure corresponds to transmitting the signal at a fraction of the original transmission power in the first direction and transmitting the second part of the signal in the opposite direction on the fibre ring structure corresponds to transmitting the signal with a transmission power equal to the original transmission power minus the fraction of the original transmission power in the opposite direction on the fibre ring structure.

13. The optical distribution network according to claim 11, wherein the signal transmitted before detection of the fault or failure comprises a plurality of wavelengths and the signal is transmitted in the first direction, wherein transmitting the first part of the signal in the first direction on the fibre ring structure corresponds to transmitting some of the wavelengths of the plurality of wavelengths in the first direction and transmitting the second part of the signal in the opposite direction on the fibre ring structure corresponds to transmitting the remaining wavelength or wavelengths of the plurality of wavelengths in the opposite direction on the fibre ring structure.

14. The optical distribution network according claim 11, wherein the CO further is adapted to locate where on the fibre ring structure the fault or failure has occurred; and determining a size of a fraction of an original transmission power to be sent in the first direction and a size of the original transmission power minus the fraction of the original transmission power to be sent in the opposite direction or determining which wavelengths of a plurality of wavelengths to be transmitted in the first direction and which remaining wavelength or wavelengths to be transmitted in the opposite direction based on a location of the fault or failure.

15. A method performed by an optical device having a first, a second and a third port, each port being operable as both an input and an output interface, the method comprising:
receiving an input signal on one of the three ports;
splitting the received input signal into two portions: and
transmitting each of the respective two portions of the received input signal on the other two ports, and wherein:
when the input signal is received on the first port, the method comprises splitting the received input signal and outputting a first portion, A, of the received input signal through the second port and outputting a second portion, B, of the received input signal through the third port, wherein the first portion A of the received input signal is larger than the second portion B of the received input signal;
when the input signal is received on the second port, the method comprises splitting the received input signal and outputting a first portion, C, of the received input signal through the first port and outputting a second portion, D, of the received input signal through the third port, wherein the first portion C of the received input signal is larger than the second portion D of the received input signal; and
when the input signal is received on the third port, the method comprises splitting the received input signal and outputting a first portion, E, of the received input signal to the first port and outputting a second portion, F, of the received input signal to the second port.

16. The method according to claim 15, wherein the received input signal has a signal power, wherein splitting the received input signal into the first portion A, C or E and the second portion B, D or F comprises directing a fraction of the signal power to the second portion B, D or F and the remaining signal power to the first portion A, C or E, wherein the power of the fraction of the signal power directed to the second portion B or D is respectively smaller than the power of the remaining signal power directed to the first portion A or C.

17. The method according to claim 16, wherein the fraction of the signal power directed to the second portion B or D is maximum 40% of the signal power, wherein the remaining signal power directed to the first portion A or C is minimum 60% of the signal power.

18. The method according to any of claim 16, wherein the fraction of the signal power directed to the second portion B or D is maximum 10% of the signal power, wherein the remaining signal power directed to the first portion A or C is minimum 90% of the signal power.

19. The method according to claim 15, wherein the received input signal comprises a plurality of wavelengths, wherein splitting the received input signal into the first portion A, C or E and the second portion B, D or F comprises directing some of the wavelengths of the received input signal to the first portion A, C or E and the remaining wavelength or wavelengths of the received input signal to the second portion B, D or F, wherein the number of wavelengths in portion A or C is respectively higher than the number of wavelengths in portion or D.

20. The method according to claim 19, wherein the number of wavelengths directed to the second portion B or D is at least 1.

21. A method performed by an optical distribution network comprising a Central Office (CO) connected to a fibre ring structure and at least two Optical Network Terminations (ONTs), the ONTs being connected to the CO by the fibre ring structure, wherein each ONT is connected to the fibre ring structure by means of a respective optical device, the method comprising the CO transmitting a signal to the ONTs in either direction of the fibre ring structure, the optical devices respectively receiving the signal from the CO, directing a fraction of the received signal to a respective ONT and directing a remaining portion of the signal to the ring structure.

22. The method according to claim 21, wherein a first port and a second port of the respective optical devices are connected to the fibre ring structure and a third port of the respective optical devices are connected to the respective ONTs, and wherein at least one optical device operates on the signal by:
when the signal is received on the first port, splitting the signal and outputting a first portion, A, of the signal through the second port and outputting a second portion, B, of the signal through the third port, wherein the first portion A of the signal is larger than the second portion B of the signal; and
when the signal is received on the second port, splitting the signal and outputting a first portion, C, of the signal through the first port and outputting a second portion, D, of the signal through the third port, wherein the first portion C of the signal is larger than the second portion D of the signal.

23. The method according to claim 22, further comprising the CO detecting a fault or failure on the fibre ring structure, and in response to detecting the fault or failure, changing a transmission direction of at least a part of the signal on the fibre ring structure.

24. The method according to claim 23, further comprising the CO, in response to detecting the fault or failure, transmitting a first part of the signal in a first direction of the fibre ring structure and transmitting a second part of the signal in the opposite direction on the fibre ring structure.

25. The method according to claim 24, wherein the signal is transmitted with an original transmission power before detection of the fault or failure and in the first direction, wherein transmitting the first part of the signal in the first direction of the fibre ring structure corresponds to transmitting the signal at a fraction of the original transmission power in the first direction and transmitting the second part of the signal in the opposite direction on the fibre ring structure corresponds to transmitting the signal with a transmission power equal to the original transmission power minus the fraction of the original transmission power in the opposite direction on the fibre ring structure.

26. The method according to claim 24, wherein the signal transmitted before detection of the fault or failure comprises a plurality of wavelengths and the signal is transmitted in the first direction, wherein transmitting the first part of the signal in the first direction on the fibre ring structure corresponds to transmitting some of the wavelengths of the plurality of wavelengths in the first direction and transmitting the second part of the signal in the opposite direction on the fibre ring structure corresponds to transmitting the remaining wavelength or wavelengths of the plurality of wavelengths in the opposite direction on the fibre ring structure.

27. The method according to claim 24, further comprising the CO further locating where on the fibre ring structure the fault or failure has occurred; and determining a size of a fraction of an original transmission power to be sent in the first direction and a size of the original transmission power minus the fraction of the original transmission power to be sent in the opposite direction or determining which wavelength or wavelengths of a plurality of wavelengths to be transmitted in the first direction and which remaining wavelength or wavelengths to be transmitted in the opposite direction based on a location of the fault or failure.
